(19) United States
(12) Patent Application Publication
(10) Pub. No.: US 2014/0125631 A1
(43) Pub. Date: May 8, 2014

(54) LARGE MULTI-TOUCH ELECTRONIC WHITEBOARD

(71) Applicant: PHIHONG TECHNOLOGY CO., LTD., Taoyuan County (TW)

(72) Inventors: Allan LIN, Taipei City (TW); Wen Lung TSAI, New Taipei City (TW)

(21) Appl. No.: 13/862,049

(22) Filed: Apr. 12, 2013

(30) Foreign Application Priority Data
Nov. 5, 2012 (TW) 101141056

(51) Int. Cl. G06F 3/041; G06F 3/043; G06F 3/042

(52) U.S. Cl. CPC G06F 3/0412; G06F 3/042; G06F 3/043
USPC 345/175; 345/173; 345/177

(57) ABSTRACT

A large multi-touch electronic whiteboard comprises: a swivel holder and a gravity sensor to adjust the screen rendering in response to the rotation of the screen; and a virtual key displayed on the screen for transmitting a tile to a mobile device via the Bluetooth device when the virtual key is clicked.

### FIELD OF THE INVENTION

The present invention is relevant to a touch electronic whiteboard, especially a large multi-touch electronic whiteboard.

### DESCRIPTION OF THE PRIOR ART

The large-scale multimedia electronic whiteboards are mainly installed in public places, including: school classrooms, halls, exhibition halls, railway stations, etc. The large-scale multimedia electronic whiteboards are usually composed of computers, touch whiteboards, projectors, audio players, microphones and other electronic equipments.

With the development of the large-scale multimedia electronic whiteboards, the advertisements tend to utilize the large-scale multimedia electronic whiteboards in outdoors. Currently, the large-scale electronic whiteboards are widely used in the global transportation, banking, finance, shopping malls, and enterprises. However, large-scale multimedia electronic whiteboards have to continue to provide innovative products in order to meet requirement of the markets, and have to provide a variety of products according to the requirements of customers in different industries.

For example, commercial large-scale electronic whiteboards may be installed in airports and shopping malls. And, the airport information and shopping information can be provided to consumers. The touching function of the screen can provide the interactive and timely information for visitors. The electronic billboards can be applied to different places and provide a variety of applications, and are suitable for restaurants or retailers to play advertising contents in the forms of photos or videos.

However, the traditional large-scale multimedia electronic whiteboards usually require a lot of manpower or money to develop the system. Further, the development of the system has to catch up the latest technologies and trends, and thus the equipment vendors and the companies to buy the equipment have to spend a great deal of manpower and money.

Further, the displaying of the screens of the traditional large-scale multimedia electronic whiteboards is fixed to the portrait view, while sometimes the landscape view is better than the portrait view. And, sometimes the desired file formats are not supported by the systems of large-scale multimedia electronic whiteboards, and it also results in the bad user experience.

The invention aims to solve the above-mentioned issues.

### SUMMARY OF THE INVENTION

The present invention aims to solve the above problems.

The system of the present invention may be the open source systems, such as Google Android system. Because the open source system is free, the manufactures save the cost for development and upgrade.

The invention provides a large multi-touch electronic whiteboard with a rotatable bracket on back of the screen to rotate the screen relative to the rotatable bracket; and a gravity sensor to detect rotation of the screen and inform the motherboard to adjust the images displayed in the screen to portrait view or landscape view. Therefore, the images displayed in the screen can be adjusted to portrait view or landscape view according to the rotation of the large multi-touch electronic whiteboard of the present invention.

The present invention provides a dual system of large multi-touch electronic whiteboard, when the format of desired files is not supported by the system itself, an external computer connected to the large multi-touch electronic whiteboard can be used to play the desired files.

The present invention provides a large multi-touch electronic whiteboard comprising: a download virtual button displayed on the screen, wherein a file is transmitted to and received by a mobile device through the wireless fidelity device, the Bluetooth device or the near-field communication device when the download virtual button is clicked. Therefore, the invention can provide direct and convenient file access for users.

The invention provides a large multi-touch electronic whiteboard, including: a motherboard deployed with an open source system; a screen with a diagonal greater than inches and containing the motherboard; a driving board for receiving commands from the motherboard and driving the screen to render images; a touching frame covering a front side of the screen, wherein the screen is directly or indirectly connected to the motherboard by a universal serial bus; a wireless fidelity device to connect to a wireless network; a rotatable bracket on back of the screen to rotate the screen relative to the rotatable bracket; a gravity sensor to detect rotation of the screen and inform the motherboard to adjust the images displayed in the screen to portrait view or landscape view.

The electronic whiteboard of the invention further comprises one or more of: a Bluetooth device receiving and sending Bluetooth signals through Bluetooth communication; a near-field communication device for receiving and transmitting near-field communication signals through near-field communication; an antenna for receiving a frequency modulated signal or an amplitude modulated signal; a camera; a loudspeaker; a microphone.

The electronic whiteboard of the invention further comprises a switch connected to a computer outside of the screen, the motherboard, and the driving board and used to switching a master controlling system between the computer and the motherboard to provide a dual-system controlling.

### BRIEF DESCRIPTION OF THE DRAWINGS

The primitive objectives and advantages of the present invention will become apparent upon reading the following description and upon reference to the accompanying drawings in which:

FIG. 1A shows a large multi-touch electronic whiteboard in accordance with an embodiment of the present invention, wherein the screen is placed in landscape shape.

FIG. 1B shows a large multi-touch electronic whiteboard in accordance with an embodiment of the present invention, wherein the screen is placed in portrait shape.

FIG. 2A shows the inner structure of a large multi-touch electronic whiteboard in accordance with an embodiment of the present invention.

FIG. 2B shows the inner structure of a large multi-touch electronic whiteboard with a dual system in accordance with an embodiment of the present invention.

FIG. 3A shows a large multi-touch electronic whiteboard provided to down files according to another embodiment the invention.

FIG. 3B shows a large multi-touch electronic whiteboard provided to sell the tickets according to another embodiment the invention.

FIG. 4 shows a mobile device receiving the ticket according to another embodiment of the invention.

### DESCRIPTION OF THE PREFERRED EMBODIMENT

In order to fully understand the manner in which the above-recited details and other advantages and objects according to the invention are obtained, a more detailed description of the invention will be rendered by reference to the best-contemplated mode and specific embodiments thereof. The following description of the invention is made for the purpose of illustrating the general principles of the invention and should not be taken in a limiting sense; it is intended to illustrate various embodiments of the invention. As such, the specific modifications discussed are not to be construed as limitations on the scope of the invention. It will be apparent to one skilled in the art that various equivalents, changes, and modifications may be made without departing from the scope of the invention, and it is understood that such equivalent embodiments are to be included herein. The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this detailed description section. Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list.

Preferred embodiments and aspects of the invention will be described to explain the scope, structures and procedures of the invention. In addition to the preferred embodiments of the specification, the present invention can be widely applied in other embodiments.

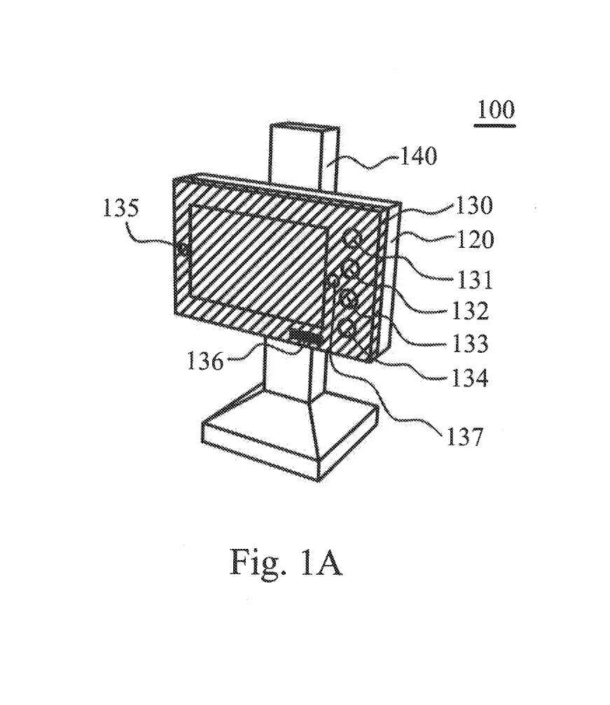

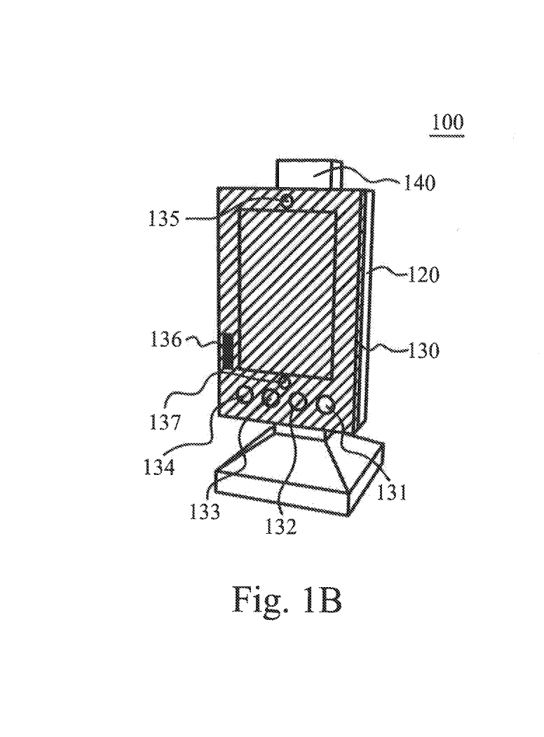

FIG. 1A shows a large multi-touch electronic whiteboard 100 in accordance with an embodiment of the present invention, wherein the screen 120 is placed in landscape shape. FIG. 1B shows a large multi-touch electronic whiteboard 100 in accordance with an embodiment of the present invention, wherein the screen 120 is placed in portrait shape.

By referring to FIGS. 1A and 1B, the invention provides a large multi-touch electronic whiteboard 100 with a rotatable bracket 140 on back of the screen 120 to rotate the screen 120 relative to the rotatable bracket 140, and the screen 120 of the large multi-touch electronic whiteboard 100 is placed from the landscape shape of FIG. 1A to the portrait shape of FIG. 1B. Among them, the large multi-touch electronic whiteboard 100 may further comprise a gravity sensor to detect the rotation of the screen 120 and inform the motherboard 202 to adjust the images displayed in the screen 120 to portrait view or landscape view.

By referring to FIGS. 1A and 1B, a large multi-touch electronic whiteboard 100 includes: a screen 120 with a diagonal greater than 30 inches and containing the motherboard 202; and a touching frame 130 covering a front side of the screen 120.

Alternatively, the large multi-touch electronic whiteboard of the invention further comprises one or more of: a wireless fidelity (WIFI) device (not shown) to connect to a wireless network; a Bluetooth device (not shown) for receiving and sending Bluetooth signals through Bluetooth communication; an antenna (not shown) for receiving a frequency modulated signal or an amplitude modulated signal; a camera 135; a loudspeaker 136; a microphone 137. Alternatively, the screen 120 may have one or more buttons (131 to 134).

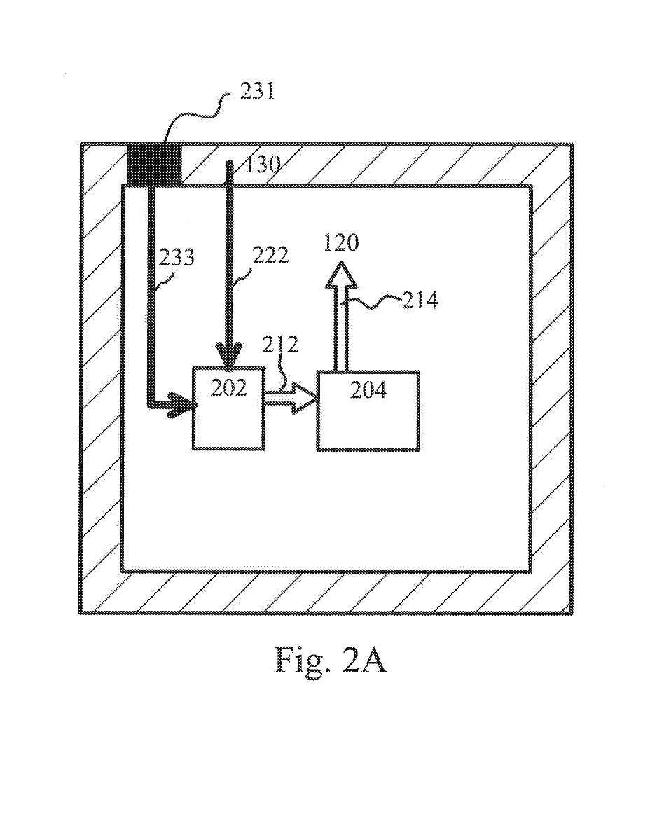

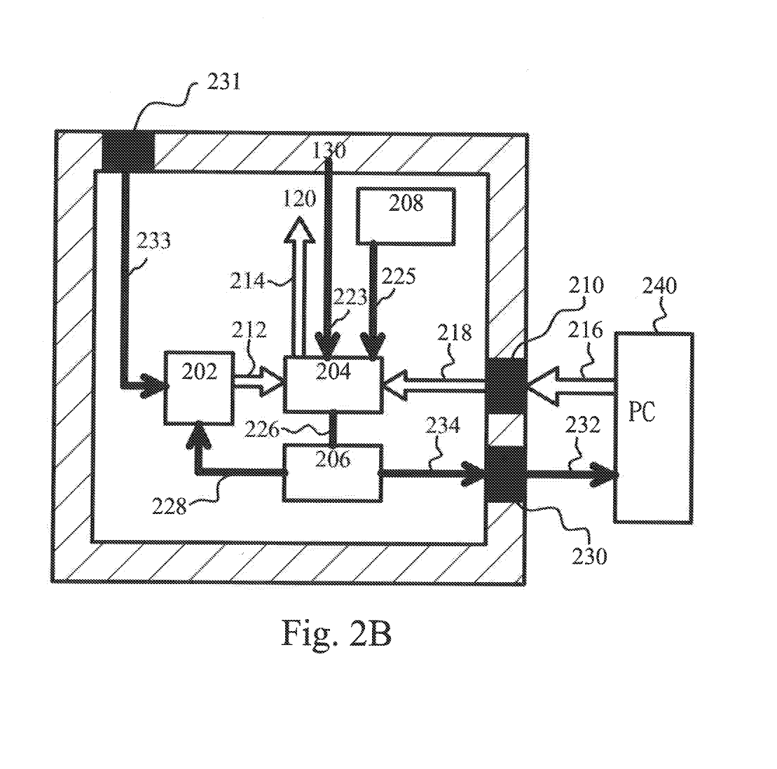

FIG. 2A shows the inner structure of a large multi-touch electronic whiteboard in accordance with an embodiment of the present invention. As shown, the large multi-touch electronic whiteboard of the invention further comprises a motherboard 202 deployed with an open source system; and a driving board 204 for receiving commands from the motherboard 202 and driving the screen 120 to render images. Alternatively, a touching frame 130 is connected to the motherboard 202 by a universal serial bus 222 to control the motherboard 202. The video signal is transmitted from the motherboard 202 to the driving board 204 via a video transmission line 212, and transmitted to the screen 120 via the video line 214, wherein the video transmission line 212 may be a high-definition multimedia interface (HDMI) cable.

Alternatively, the touching frame 130 of the large multi-touch electronic whiteboard may be an optical touching frame, an acoustic touching frame, or an infrared touching frame.

Alternatively, the motherboard 202 may perform a recording program to record programs used and counts of using the electronic whiteboard.

Moreover, the motherboard 202 may perform a controlling program to be controlled locally or remotely via the wireless network to decide which programs are used. Further, the motherboard 202 may perform an advertising controlling program to be controlled locally or remotely via the wireless network to decide which advertisements are displayed. Therefore, when lots of the large multi-touch electronic whiteboards are deployed in the scattered positions, we do not need to set them one by one and thus save a lot of manpower.

Alternatively, as shown in FIG. 2A, the large multi-touch electronic whiteboard of the present invention further comprises a universal serial bus port 231, which is connected to the motherboard 202 by a bus 233. The Universal Serial Bus port 231 is provided to be connected with the Universal Serial Bus devices, for example, the Universal Serial Bus flash drive to store, read and replicate information, videos, pictures, etc.

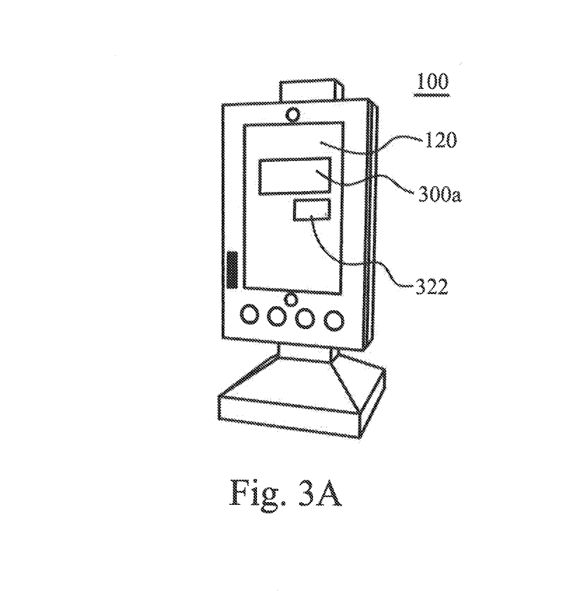

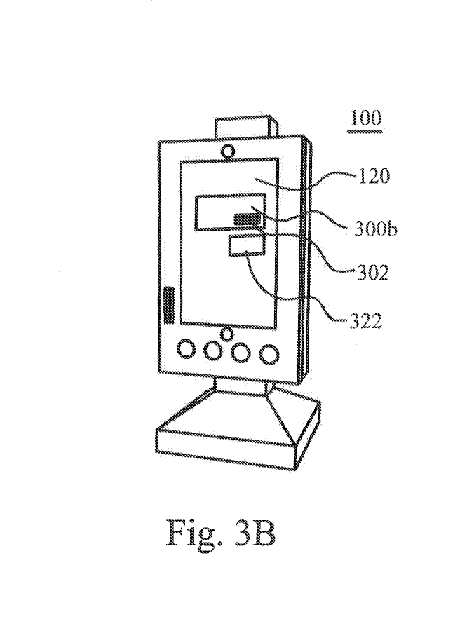

FIG. 3A shows a large multi-touch electronic whiteboard provided to down files according to another embodiment the invention. As shown, the large multi-touch electronic whiteboard 100 may display a file 300a and a download virtual button 322 on the screen 120. When a user wants to download the file 300a, the user can click the download virtual button 322 to download the file 300a. And, the large multi-touch electronic whiteboard 100 can transmit the file 300a out by a wireless device (e.g., a Bluetooth device, a near field communication device or a wireless fidelity device), and thus a mobile device of the user can receive the file 300a.

Alternatively, the wireless device may be a near-field communication device, and the large multi-touch electronic whiteboard 100 may detect the radio frequency identification (RFID) or an electronic tag (etag) on the mobile device to decide that the user is allowed to download the file.

FIG. 3B shows a large multi-touch electronic whiteboard provided to sell the tickets according to another embodiment the invention. As shown, the large multi-touch electronic whiteboard 100 may display a ticket 300b and a download virtual button 322 on the screen 120. When a user wants to purchase the ticket 300b, the user can click the download virtual button 322. And, the large multi-touch electronic whiteboard 100 can transmit the file of the ticket 300a out by a wireless device (e.g., a Bluetooth device, a near field communication device or a wireless fidelity device), and thus a mobile device of the user can receive the file of the ticket 300b. Alternatively, the ticket 300b may comprise a two-dimensional barcode 302.

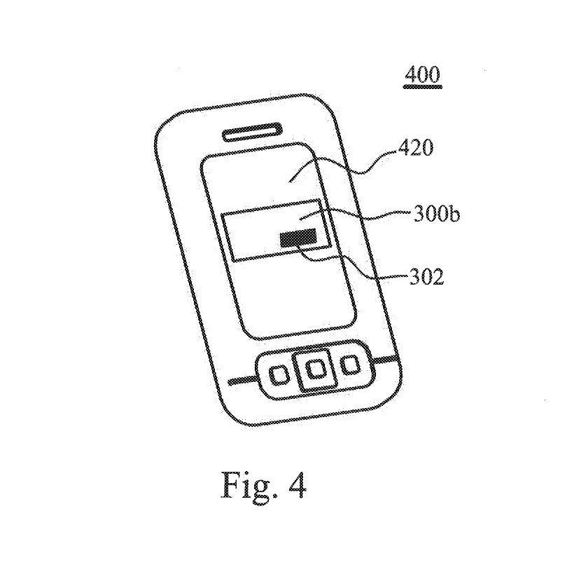

FIG. 4 shows a mobile device 400 receiving the ticket 300b according to another embodiment of the invention. Alternatively, the screen 420 of the mobile device 400 may display the ticket 300b containing a two-dimensional barcode 302. The ticket 300b is provided for a scanner to read the information from the two-dimensional bar code 302.

In another aspect, the large touch electronic whiteboard of the present invention may be a large multi-touch electronic whiteboard with a dual system. When the format of the desired file is not supported by the system of the large multi-touch electronic whiteboard, the desired file can be played by the large multi-touch electronic whiteboard by connecting to an external computer.

FIG. 2B shows the inner structure of a large multi-touch electronic whiteboard with a dual system in accordance with an embodiment of the present invention. The large touch electronic whiteboard of the present invention may further include a switch 206, wherein the switch 206 may be a virtual machine switch for keyboard, video and mouse (KVM switch). The switch 206 is connected to the driving board 204 by a bus 226.

As shown in FIG. 2B, one end of the switch 206 is connected to the Universal Serial Bus port 230 by a Universal Serial Bus 234, and the Universal Serial Bus port 230 is connected to a computer 240 outside of the screen 120 by the Universal Serial Bus 232. The other end of the switch 206 is connected to the motherboard 202 by a universal serial bus 228. Thus, the switch 206 can be used to switch the master controlling system between the computer 240 and the motherboard 202 to provide a dual-system controlling. When choosing the computer 240 as a master controlling system, the video signal from the computer 240 is sent to the driving board 204 through a video line 216, the video input port 210, a video transmission line 218 sequentially; and then sent to the screen 120 through the a video line 214 to render the image on the screen 120. Alternatively, the video line 216 may a high-definition multimedia interface (HDMI) line, Digital Visual Interface (DVI) line, or Video Graphics Array (VGA) line, and the video input port 210 may be a high-definition multimedia interface input port, Digital Visual Interface input port, or Video Graphics Array input port. Alternatively, the touching frame 130 is connected to the driving board 204 by a universal serial bus 223, and then connected to the switch 206 via a bus 226.

Alternatively, a virtual button may be displayed on the screen 120, and when pressing the position of the touching frame 130 corresponding to the virtual button, the signals are transmitted to the switching 206 to switch the master controlling system between the computer 240 and the motherboard 202.

Further, the screen 120 may have a physical button, which may be used to send a switching signal to the switch 206 to switch the master controlling system between the computer 240 and the motherboard 202.

As shown in FIG. 2B, the large multi-touch electronic whiteboard of the present invention further comprises a receiver 208, which is connected by a signal transmission line 225 to the driving board 204, and is used for receiving signals from a remote control. The driving board 204 is connected to the switch 206 by a bus 226, and thus a signal from a remote control can be transmitted to the switch 206 to switch the master controlling system between the computer 240 and the motherboard 202. Alternatively, the remote control may be an infrared remote control.

Alternatively, as shown in FIG. 2B, the large multi-touch electronic whiteboard of the present invention further comprises a universal serial bus port 231, which is connected to the motherboard 202 by a bus 233. The Universal Serial Bus port 231 is provided to be connected with the Universal Serial Bus devices, for example, the Universal Serial Bus flash drive to store, read and replicate information, videos, pictures, etc.

The foregoing description, for purposes of explanation, was set forth in specific details of the preferred embodiments to provide a thorough understanding of the invention. However, it will be apparent to one skilled in the art that specific details are not required in order to practice the invention. Therefore, the foregoing descriptions of specific embodiments of the invention are presented for purposes of illustration and description only and should not be construed in any way to limit the scope of the invention. They are not intended to be exhaustive or to limit the invention to the precise forms disclosed; obviously, many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following Claims and their equivalents define the scope of the invention.

The above-described embodiments of the present invention are intended to be illustrative only. Numerous alternative embodiments may be devised by those skilled in the art without departing from the scope of the following claims.

What is claimed is:

1. A large multi-touch electronic whiteboard 100, including:
a motherboard 202 deployed with an open source system;
a screen 120 with a diagonal greater than 30 inches and containing the motherboard 202;
a driving board 204 for receiving commands from the motherboard 202 and driving the screen 120 to render images;
a touching frame 130 covering a front side of the screen 120, wherein the screen 120 is directly or indirectly connected to the motherboard 202 by a universal serial bus;
a wireless fidelity device to connect to a wireless network;
a rotatable bracket 140 on back of the screen 120 to rotate the screen 120 relative to the rotatable bracket 140; and
a gravity sensor to detect rotation of the screen 120 and inform the motherboard 202 to adjust images displayed in the screen 120 to portrait view or landscape view.

2. The electronic whiteboard of claim 1, further comprising:
a download virtual button 322 displayed on the screen 120, wherein a file is transmitted to and received by a mobile device 400 through the wireless fidelity device when the download virtual button 322 is clicked.

3. The electronic whiteboard of claim 2, wherein the file contains a two-dimensional bar code 302 for being displayed on a screen 420 of the mobile device 400 to be scanned by a scanner.

4. The electronic whiteboard of claim 1, wherein the touching frame 130 is an optical touching frame.

5. The electronic whiteboard of claim 1, wherein the touching frame 130 is an acoustic touching frame.

6. The electronic whiteboard of claim 1, wherein the touching frame 130 is an infrared touching frame.

7. The electronic whiteboard of claim 1, wherein the motherboard 202 performs a recording program to record programs used and counts of using the electronic whiteboard.

8. The electronic whiteboard of claim 1, wherein the motherboard 202 performs a controlling program to be controlled locally or remotely via the wireless network to decide which programs are used.

9. The electronic whiteboard of claim 1, wherein the motherboard 202 performs an advertising controlling program to be controlled locally or remotely via the wireless network to decide which advertisements are displayed.

10. The electronic whiteboard of claim 1, further comprising:
a switch 206 connected to a computer 240 outside of the screen 120, the motherboard 202, and the driving board 204 and used to switching a master controlling system between the computer 240 and the motherboard 202 to provide a dual-system controlling;
a Universal Serial Bus port 230, wherein the computer 240 is connected to the switch 206 via the Universal Serial Bus port 230; and
a video input port 210, wherein the computer 240 is connected to the driving board 204 via the video input port 210.

11. The electronic whiteboard of claim 10, further comprising:
a receiver for receiving signals from a remote control, and transmitting the signals to the switch 206, to switch the master controlling system between the computer 240 and the motherboard 202.

12. The electronic whiteboard of claim 10, further comprising:
a virtual button displayed on the screen 120, when pressing position of the touching frame 130 corresponding to the virtual button, the signals are transmitted to the switching 206 to switch the master controlling system between the computer 240 and the motherboard 202.

13. The electronic whiteboard of claim 10, further comprising:
a physical button for transmitting the signals to the switch 206 to switch the master controlling system between the computer 240 and the motherboard 202.

14. The electronic whiteboard of claim 1, further comprising:
a Bluetooth device for receiving and sending Bluetooth signals through Bluetooth communication.

15. The electronic whiteboard of claim 14, further comprising:
a download virtual button 322 displayed on the screen 120, wherein a file is transmitted to and received by a mobile device 400 through the Bluetooth device when the download virtual button 322 is clicked.

16. The electronic whiteboard of claim 1, further comprising:
a near-field communication device for receiving and transmitting near-field communication signals through near-field communication.

17. The electronic whiteboard of claim 16, further comprising:
a download virtual button 322 displayed on the screen 120, wherein a file is transmitted to and received by a mobile device 400 through the near-field communication device when the download virtual button 322 is clicked.

18. The electronic whiteboard of claim 1, further comprising:
an antenna for receiving a frequency modulated signal or an amplitude modulated signal.

19. The electronic whiteboard of claim 1, further comprising a camera 135 or a microphone 137.

20. The electronic whiteboard of claim 1, further comprising a loudspeaker 136.
